(19) United States
(12) Patent Application Publication
(10) Pub. No.: US 2010/0037244 A1
(43) Pub. Date: Feb. 11, 2010

(54) Method for Providing Inline Service-Oriented Architecture Application Fragments

(75) Inventors: STEVEN J. BRANDA, Rochester, MN (US); WILLIAM T. NEWPORT, Rochester, MN (US); JOHN J. STECHER, Rochester, MN (US); ROBERT WISNIEWSKI, Rochester, MN (US)

Correspondence Address: IBM CORPORATION, 3605 HIGHWAY 52 NORTH, DEPT 917, ROCHESTER, MN, 55901-7829, US

(73) Assignee: INTERNATIONAL BUSINESS MACHINES CORPORATION, Armonk, NY (US)

(21) Appl. No.: 12/188,339

(22) Filed: Aug. 8, 2008

(51) Int. Cl. G06F 9/46

(52) U.S. Cl. 719/330

(57) ABSTRACT

A method for providing inline service-oriented architecture application fragments is disclosed. A remote procedure call is initially from a client application executing on a first data processing system by an application server executing on a second data processing system. The remote procedure call is a call to execute a service in a service-oriented architecture hosted by the application server. The remote procedure call includes a metadata tag indicating a preference for having computer-executable code corresponding to the service transmitted from the second data processing system to the first data processing system for execution on the first data processing system. A determination is made whether or not the service supports transmitting computer-executable code. If the service supports the transmitting computer-executable code, a service unit of work is transmitted to the first data processing system. If the service does not support transmitting executable code, the service is executed by the second data processing system to generate a result.

### BACKGROUND OF THE INVENTION

1. Technical Field

The present invention relates to computers and computer systems in general, and more particularly, to a method for providing inline service-oriented architecture application fragments.

2. Description of Related Art

Companies have long sought to integrate existing systems in order to implement information technology (IT) support for business processes that cover all present and prospective systems requirements needed to run the business end-to-end. A flexible, standardized architecture is required to better support the connection of various applications and the sharing of data. Service-Oriented Architecture is one such architecture.

Service-Oriented Architecture (SOA) is an architectural style that guides all aspects of creating and using business processes, packaged as services, throughout their lifecycle, as well as defining and provisioning the IT infrastructure that allows different applications to exchange data and participate in business processes loosely coupled from the operating systems and programming languages underlying those applications. SOA represents a model in which functionality is decomposed into small, distinct units which can be distributed over a network and can be combined together and reused to create business applications. These services communicate with each other by passing data from one service to another, or by coordinating an activity between two or more services.

An SOA unifies business processes by structuring large applications as an ad-hoc collection of smaller modules called services. These applications can be used by different groups of people both inside and outside the company, and new applications built from a mix of services from the global pool exhibit greater flexibility and uniformity. A user should not, for example, have to redundantly provide the same personal information to open an online checking and savings account. Furthermore, the interfaces with which the user interacts should have the same look and feel and use the same level and type of input data validation. Building all applications from the same pool of services makes achieving this goal much easier and more deployable to affiliate companies. For example, a user might be interacting with a rental car company's reservation system even though the user is doing so from an airline reservation system.

An SOA builds applications out of software services. Services are relatively large, intrinsically unassociated units of functionality which have no calls to each other embedded within them. They typically implement functionalities most humans would recognize as a service, such as filling out an online application for an account, viewing an online bank statement, or placing an online booking or airline ticket order. Instead of services embedding calls to each other in their source code, protocols are defined which describe how one or more services can talk to each other. This architecture then relies on a business process expert to link and sequence services to meet a new or existing business system requirement.

One of the main problems with SOAs in use today is that performance of an application is typically reduced as the application is divided into more services. The services that reside on remote systems are accessed over a computer network using remote procedure calls (RPC). The latency associated with a remote procedure call increases the time required for the application to receive critical application data. As the application is divided into a greater number of services on remote systems, the latency of each RPC can severely degrade the performance of the application. When application developers rely too much on dividing an application into services and the associated performance degradation results in the application being unable to meet business level service level agreements (SLA). In response, many developers end up rebuilding the same components provided by services into the applications they develop to improve application performance, which defeats the purpose of an SOA and does not leverage other services that developers have written.

### SUMMARY OF THE INVENTION

In accordance with a preferred embodiment of the present invention, a remote procedure call is initially from a client application executing on a first data processing system by an application server executing on a second data processing system. The remote procedure call is a call to execute a service in a service-oriented architecture hosted by the application server. The remote procedure call includes a metadata tag indicating a preference for having computer-executable code corresponding to the service transmitted from the second data processing system to the first data processing system for execution on the first data processing system. A determination is made whether or not the service supports transmitting computer-executable code. If the service supports the transmitting computer-executable code, a service unit of work is transmitted to the first data processing system. If the service does not support transmitting executable code, the service is executed by the second data processing system to generate a result.

All features and advantages of the present invention will become apparent in the following detailed written description.

### BRIEF DESCRIPTION OF THE DRAWINGS

The invention itself, as well as a preferred mode of use, further objects, and advantages thereof, will best be understood by reference to the following detailed description of an illustrative embodiment when read in conjunction with the accompanying drawings, wherein:

FIG. 1 is a block diagram of a data processing system in which a preferred embodiment of the present invention may be implemented;

FIG. 2 is a block diagram of a service-oriented architecture in which a preferred embodiment of the present invention may be implemented;

FIG. 3 is a block diagram showing how computer code is executed between a client system and a server system, in accordance with a preferred embodiment of the present invention; and

FIG. 4 is a high-level logic flow diagram of a method for streaming executable code by an application server, in accordance with a preferred embodiment of the present invention.

### DETAILED DESCRIPTION OF A PREFERRED EMBODIMENT

An illustrative embodiment of the present invention is described in detail for providing an application server runtime and environment that supports the secure streaming of computer-executable code in the form of a service unit of work (SUOW) and the ability to provide access to libraries required for remote execution of an SUOW. The application server manages the life cycles of the various SUOWs deployed by the application server. The management of the life cycle of an SUOW includes streaming of the units of binary code and required resource files, notification of remote machines that have had SUOW streamed to them that changes on the main service have occurred and that the remote machine needs to reload the SUOW, as well as terminating remote SUOW execution. The present invention can take the form of an entirely hardware embodiment, an entirely software embodiment or an embodiment containing both hardware and software elements.

Furthermore, the present invention can take the form of a computer program product accessible from a computer-usable or computer-readable medium providing program code for use by or in connection with a computer or any instruction execution system.

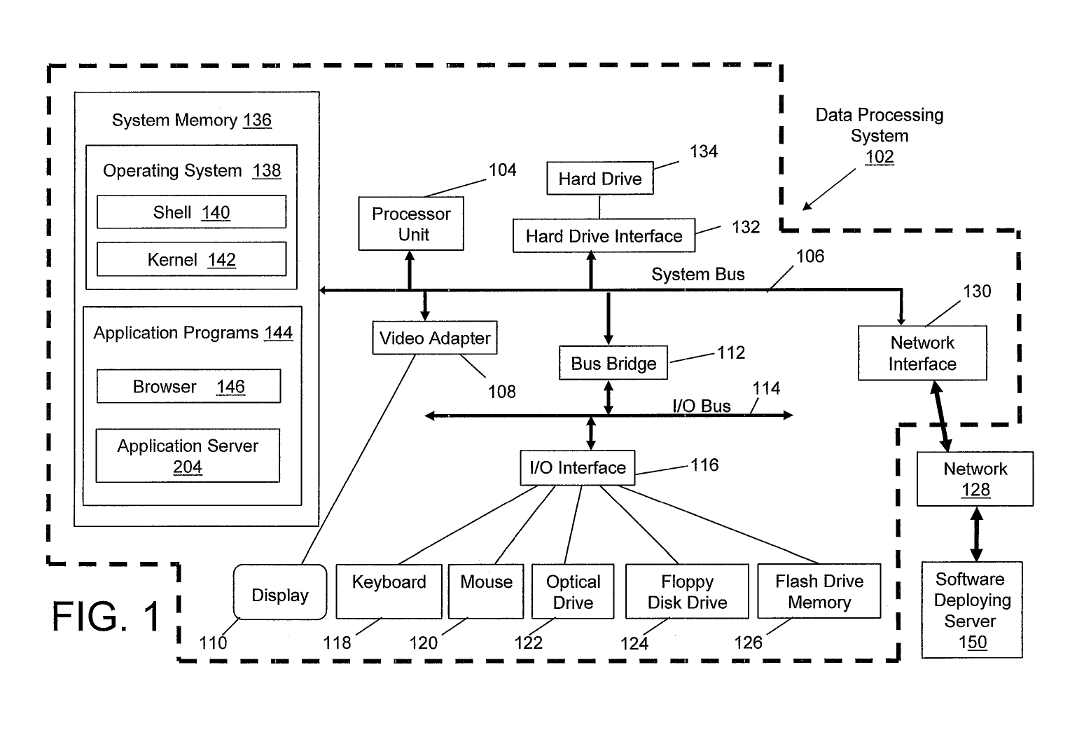

With reference now to the drawings, and in particular to FIG. 1, there is illustrated a block diagram of a data processing system suitable for storing and/or executing program code in accordance with a preferred embodiment of the present invention. As shown, a data processing system 102 includes a processor unit 104 that is coupled to a system bus 106. A video adapter 108, which drives/supports a display 110, is also coupled to system bus 106. System bus 106 is coupled via a bus bridge 112 to an Input/Output (I/O) bus 114. An I/O interface 116 is coupled to I/O bus 114. I/O interface 116 affords communication with various I/O devices, including a keyboard 118, a mouse 120, an optical disk drive 122, a floppy disk drive 124, and a flash drive memory 126. The format of the ports connected to I/O interface 116 may be any known to those skilled in the art of computer architecture, including but not limited to Universal Serial Bus (USB) ports.

Data processing system 102 is able to communicate with a software deploying server 150 via a network 128 using a network interface 130, which is coupled to system bus 106. Network 128 may be an external network such as the Internet, or an internal network such as an Ethernet or a Virtual Private Network (VPN). Software deploying server 150 may utilize a similar architecture design as that described for data processing system 102.

A hard drive interface 132 is also coupled to system bus 106. Hard drive interface 132 interfaces with hard drive 134. In an illustrative embodiment, hard drive 134 populates a system memory 136, which is also coupled to system bus 106. Data that populates system memory 136 includes an operating system (OS) 138 of data processing system 102, application programs 144.

OS 138 includes a shell 140, for providing transparent user access to resources such as application programs 144. Generally, shell 140 is a program that provides an interpreter and an interface between the user and the operating system. More specifically, shell 140 executes commands that are entered into a command line user interface or from a file. Thus, shell 140 is generally the highest level of the operating system software hierarchy and serves as a command interpreter. The shell provides a system prompt, interprets commands entered by keyboard, mouse, or other user input media, and sends the interpreted command(s) to the appropriate lower levels of the operating system (e.g., a kernel 142) for processing.

As depicted, OS 138 also includes kernel 142, which includes lower levels of functionality for OS 138, including providing essential services required by other parts of OS 138 and application programs 144, including memory management, process and task management, disk management, and mouse and keyboard management.

Application programs 144 include a browser 146. Browser 146 includes program modules and instructions enabling a World Wide Web (WWW) client (such as data processing system 102) to send and receive network messages to the Internet using HyperText Transfer Protocol (HTTP) messaging, thus enabling communication with software deploying server 150.

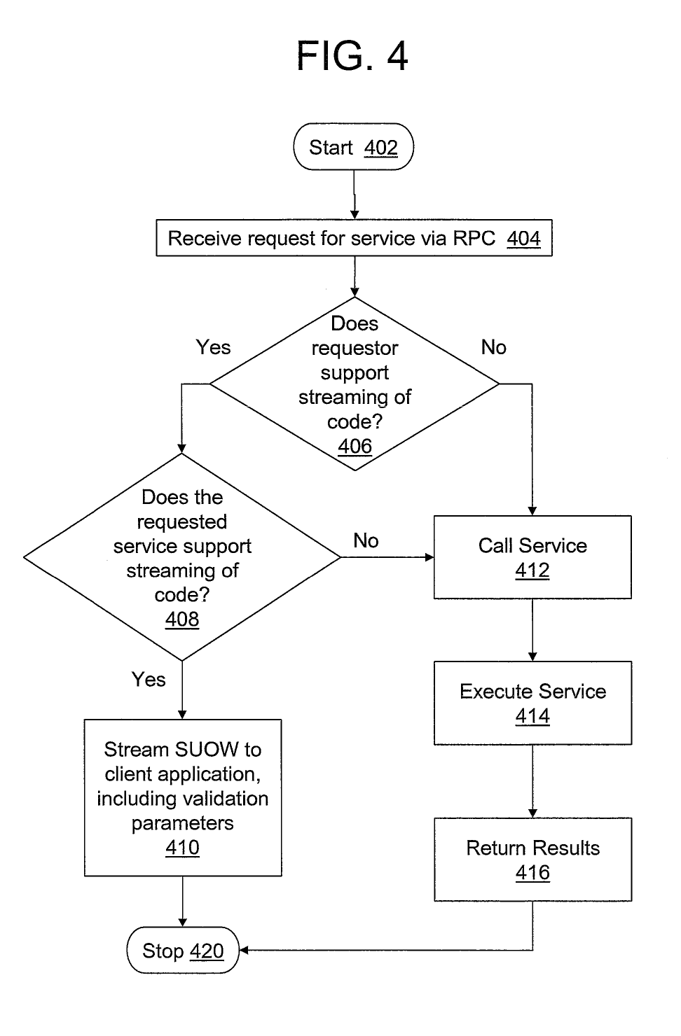

Application programs 144 in the system memory of data processing system 102 (as well as the system memory of software deploying server 150) also include application server 204. Application server 204 comprises computer-executable code, at least a portion of which implements the method described herein with reference to FIG. 4. In one embodiment, data processing system 102 is able to download application server 204 from software deploying server 150.

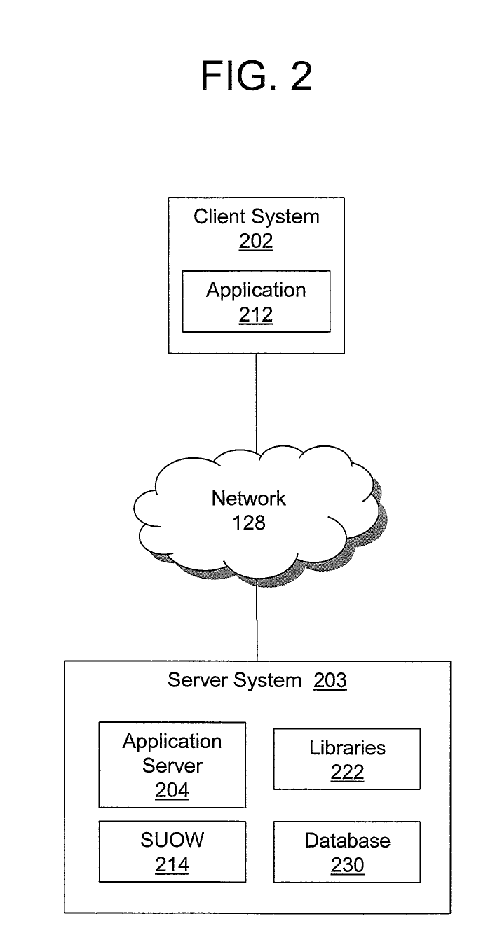

FIG. 2 shows a block diagram of a service-oriented architecture in which a preferred embodiment of the present invention can be implemented. As shown, a client system 202 and a server system 203 are data processing systems capable of communicating data with each other via a network 128. Server system 203 includes application server 204, service units of work (SUOW) 214, libraries 222 and database 230. Application server 204 provides a runtime and environment that supports the secure streaming of executable code corresponding to SUOW 214 to client system 202. Application server 204 also provides the ability to access required libraries 222 that are needed for execution of SUOW 214. SUOW 214 includes a wrapper descriptor (such as an XML wrapper descriptor) that defines the resources SUOW 214 needs to execute and any dependencies on other software components, such as information to access database 230. While FIG. 2 depicts server system 203 as including application server 204, SUOW 214, library 222 and database 230, one skilled in the art will recognize that each of these items can also be distributed among multiple server systems that are likewise capable of communicating data with each other.

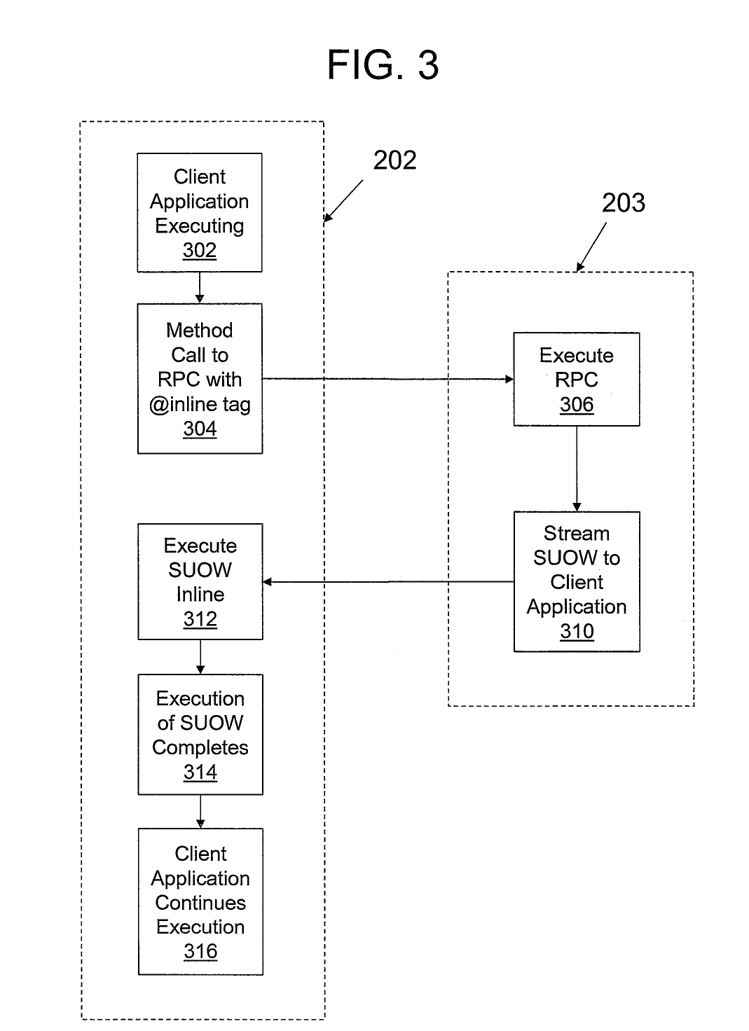

Client system 202 includes application 212 which utilizes SUOW 214. Application 212 utilizes SUOW 214 as a remote procedure calls (RPC). The method call in application 212 out to the RPC to be serviced by application server 204 is annotated with a tag denoting that application 212 supports the secure streaming of executable code. Application server 204 detects the tag. In response to detecting the tag, application server 204 streams the computer-executable code of SUOW 214 corresponding to the RPC to application 212, as described in more detail with reference to FIGS. 3-4. Streaming SUOW 214 enables client system 202 to locally execute the code corresponding to SUOW 214 instead of waiting for server system 203 to remotely execute the code corresponding to a SUOW and return the results to application 212 via RPC.

FIG. 3 is a block diagram showing how computer code is executed between client system 202 and server system 203, in accordance with a preferred embodiment of the present invention. For purposes of illustration, application 212 can be a program for opening a new credit card account with a financial institution. Application 212 is executing on client system 202 (block 302). The process for opening a new credit card account with this institution requires a credit check to be performed prior to creating the new account. SUOW 214 on server system 203 provides the facility for performing the credit check. Instead of hard-writing code that performs the functions of SUOW 214 into application 212, developers in a service oriented architecture can incorporate the functionality of SUOW 214 into application 212 by making an RPC out to SUOW 214. By making a RPC out to SUOW 214, developers of application 212 do not need to know the details of how SUOW 214 functions. The developers only need to know what arguments to pass to SUOW 214 and what results to expect in return. In additional, the developers of SUOW 214 can make revisions the code of SUOW 214, and the revisions will be transparent to application 212. The developers of application 212 do not need to rewrite application 212 to accommodate revisions to SUOW 214.

Application 212 receives input of customer information (e.g., name, address, social security number, etc.). The next step in application 212 is to perform a credit check with the input information. Application 212 makes a remote procedure call over network 128 out to SUOW 214. The method call in application 212 out to the RPC includes the tag “@inline”, indicating that application 212 is capable a receiving streamed executable code (block 304) and locally executing the code inline with application 212. On server system 203, application server 204 services the RPC made by application 212 on client system 202 (block 306). In response to detecting that the method call out to the RPC being serviced by application server 204 includes the “@inline” tag, application server 204 on server system 203 streams executable code corresponding to SUOW 214 to application 212 on client system 202 over network 128 (block 310). Application 212 receives the streaming SUOW code and client system locally executes the SUOW code inline with application 212 (block 312). All dependencies are called out in the XML wrapper of SUOW 214. If SUOW 214 requires access to database 230, the database name, machine address, and path are fully disclosed in the XML wrapper, as well as the physical location of any database drivers that are needed. Application 212 performs the credit check by executing the code of SUOW 214 locally as if it were part of application 212. The results (e.g., the customer's credit score) are returned to the method of application 212 that called out to the RPC (block 314). Application 212 continues executing (block 316), using the results to determine whether the customer is approved to open a new account.

By streaming the executable SUOW code to client system 202 for execution, performance of application 212 can be improved while maintaining a service-oriented architecture. Application 212 does not need to wait for server system 203 to execute SUOW 214 remotely, which is beneficial if server system 203 is experiencing high utilization/latency. Furthermore, in accordance with an embodiment of the present invention, SUOW 214 can be reused locally by application 212 so that client system 202 does not need to download SUOW 214 from server system 203 each time application 212 is executed. The code of SUOW 214 may be securely streamed using secure data streaming methods known in the art. Additionally, administrators of application server 204 can quickly and easily modify the XML wrapper descriptor of SUOW 214 enabling the administrators to choose which services should be streamed to client systems independent of the developers of SUOW 214. For example, if the administrators of application server 204 need to perform maintenance on server system 203 that temporarily results in reduced network bandwidth, the administrators can modify the XML wrapper descriptor of SUOW 214 so that SUOW 214 is not streamed to client systems. There is no need to have the developers of SUOW 214 alter the code of SUOW 214.

The life cycle of SUOW 214 is managed by application server 204, thereby ensuring that client system 202 is executing a current version of SUOW 214. For example, when streaming SUOW 214 to client system 202, application server 204 can include an expiry time in the XML wrapper of SUOW 214. The expiry time could be a duration (e.g., 7 days) or a specific time (e.g., May 7, 2008 at 02:00:00). Application server 204 can define a predetermined number of times that SUOW 214 can be executed by client system 202 before the local copy of SUOW 214 on client system 202 is invalidated (e.g., SUOW 214 is authorized to be locally executed 225 times before it must be downloaded again). Client system 202 may request to download a new copy of SUOW 214 in response to an error occurring during execution of the local copy of SUOW 214. Application server 214 may also keep track of the deployments of SUOW 214 and notify client systems when an updated version of SUOW 214 is available for download.

FIG. 4 is a high-level logic flow diagram of a method for streaming executable code by an application server, in accordance with a preferred embodiment of the present invention. Start at block 402, application server 204 on server system 203 receives a request for a remote procedure call (RPC) from application 212 on client system 202, a shown in block 404. Application server 204 determines whether the request includes an indication that application 212 supports the streaming of executable code, as depicted in block 406. The determination in block 406 may include detecting a tag, such as “@inline”, in the method call calling the RPC. If application 212 does not support the streaming of executable code, application server 204 calls the service requested in the RPC, as shown in block 412, server system 203 executes the service (block 414) and returns the results over network 128 to client system 202. The process then ends at block 420.

If application 212 does support the streaming of executable code, application server 204 determines whether the requested service supports the streaming of executable code. For example, application server 204 determines whether the requested service exposes a SUOW as described herein. If the requested service does not support the streaming of executable code, the process proceeds to block 412. If the requested service does support the streaming of executable code, then application server 204 streams computer-executable code corresponding to the requested service to client system 202, as shown in block 410. The streamed computer-executable code may include information identifying any data dependencies or software components needed to execute the code and the addresses needed to resolve the dependencies. The streamed computer-executable code may include information for managing the life cycle of the code. An example of the streamed computer-executable code is the SUOW described herein. The SUOW includes an XML wrapper descriptor that provides the information regarding data dependencies, software components and life cycle management of the streamed computer-executable code. Once the computer-executable code is streamed to client system 202, the process ends at terminator 420.

As has been described, the present invention provides a method for providing inline service-oriented architecture application fragments.

While the invention has been particularly shown and described with reference to a preferred embodiment, it will be understood by those skilled in the art that various changes in form and detail may be made therein without departing from the spirit and scope of the invention.

What is claimed is:

1. A method for providing inline service-oriented architecture application fragments, said method comprising:
receiving a remote procedure call from a client application executing on a first data processing system by an application server executing on a second data processing system, wherein said remote procedure call is a call to execute a service in a service-oriented architecture hosted by said application server, and wherein said remote procedure call includes a metadata tag indicating a preference for having computer-executable code corresponding to said service transmitted from said second data processing system to said first data processing system for execution on said first data processing system;
determining whether or not said service supports transmitting computer-executable code;
in response to a determination that said service supports said transmitting computer-executable code, transmitting a service unit of work to said first data processing system, wherein said service unit of work includes computer-executable code corresponding to said service that is to be executed by said first data processing system and a metadata wrapper including information needed for said first data processing system to execute said computer-executable code;
in response to a determination that said service does not support transmitting executable code,
executing said service by said second data processing system to generate a result; and
returning said result to said client application executing on said first data processing system.

2. The method of claim 1, wherein said transmitting further includes transmitting encrypted computer-executable code.

3. The method of claim 1, wherein said transmitting further includes streaming computer-executable code so that said first data processing system can begin executing a portion of said computer-executable code before all of said computer-executable code is received by said first data processing system.

4. The method of claim 1, wherein said metadata wrapper includes a predetermined time period for which said service unit of work may be executed by said first data processing system.

5. The method of claim 1, wherein said metadata wrapper specifies a predetermined threshold for the number of times which said service unit of work may be executed by said first data processing system.

6. The method of claim 1, wherein said metadata wrapper includes computer program code written in an extensible markup language.

7. A computer-readable medium having a computer program product for providing inline service-oriented architecture application fragments, said computer-readable medium comprising:
program code for receiving a remote procedure call from a client application executing on a first data processing system by an application server executing on a second data processing system, wherein said remote procedure call is a call to execute a service in a service-oriented architecture hosted by said application server, and wherein said remote procedure call includes a metadata tag indicating a preference for having computer-executable code corresponding to said service transmitted from said second data processing system to said first data processing system for execution on said first data processing system;
program code for determining whether or not said service supports transmitting computer-executable code;
program code for, in response to a determination that said service supports said transmitting computer-executable code, transmitting a service unit of work to said first data processing system, wherein said service unit of work includes computer-executable code corresponding to said service that is to be executed by said first data processing system and a metadata wrapper including information needed for said first data processing system to execute said computer-executable code;
program code for, in response to a determination that said service does not support transmitting executable code,
executing said service by said second data processing system to generate a result; and
returning said result to said client application executing on said first data processing system.

8. The computer-readable medium of claim 7, wherein said transmitting further includes transmitting encrypted computer-executable code.

9. The computer-readable medium of claim 7, wherein said transmitting further includes streaming computer-executable code so that said first data processing system can begin executing a portion of said computer-executable code before all of said computer-executable code is received by said first data processing system.

10. The computer-readable medium of claim 7, wherein said metadata wrapper includes a predetermined time period for which said service unit of work may be executed by said first data processing system.

11. The computer-readable medium of claim 7, wherein said metadata wrapper specifies a predetermined threshold for the number of times which said service unit of work may be executed by said first data processing system.

12. The computer-readable medium of claim 7, wherein said metadata wrapper includes program code written in an extensible markup language.
